(19) United States
(12) Patent Application Publication
(10) Pub. No.: US 2015/0112701 A1
(43) Pub. Date: Apr. 23, 2015

(54) SIMULATED CLINICAL CASE-BASED SYSTEMS AND METHODS FOR ASSESSMENT OF HEALTH-CARE PROFESSIONAL'S COMPETENCE IN EVALUATING AND INTERPRETING IMAGES AND DATA

(71) Applicant: American Registry for Diagnostic Medical Sonography, Inc., Rockville, MD (US)

(72) Inventors: Ellen Ruth JULIAN, Derwood, MD (US); John Edward Gocke, Western Springs, IL (US); Elizabeth Ward Langston, Brookfield, IL (US); Patricia Lucas Grier, Baltimore, MD (US); Dale Ronald CYR, Derwood, MD (US)

(73) Assignee: American Registry for Diagnostic Medical Sonography, Inc., Rockville, MD (US)

(21) Appl. No.: 14/490,442

(22) Filed: Sep. 18, 2014

Related U.S. Application Data
(60) Provisional application No. 61/893,079, filed on Oct. 18, 2013.

(51) Int. Cl. G06Q 10/06; G06Q 50/22

(52) U.S. Cl. CPC G06Q 10/06398; G06Q 50/22
USPC 705/2

(57) ABSTRACT

Systems and methods are provided for assessing competency of a health-care professional using a linear-narrative progression. The system includes a virtual console and an assessment tool. The virtual console is configured to present a clinical vignette to the health-care professional and display a series of digital images and questions to the health-care professional based on the clinical vignette. The virtual console is further configured to receive a response to each of the questions. The virtual console is also configured to display corrective instructions to the health-care professional after receiving a response to critical questions, wherein subsequent digital images and questions are based on the corrective instructions. The assessment tool is configured to assess the health-care professional's interpretation of each of the plurality of digital images.

### CROSS-REFERENCE TO RELATED APPLICATIONS

This application is related to U.S. Provisional Patent Application No. 61/893,079, which is incorporated by reference herein in its entirety.

### TECHNICAL FIELD

This application is directed to systems and methods for evaluating health-care professional competency, and more particularly, systems and methods for assessing the health-care professional's competency based on the patient's clinical history and interpretation of medical images.

### BACKGROUND

Real-life, clinical-based studies are often used to educate health-care professional trainees in order for the trainees to obtain the practical knowledge necessary to diagnose and treat patients. However, due to a variety of constraints, the amount of clinical time available to trainees is severely limited. To overcome these limitations, simulated case studies have been implemented as an educational tool, which provides ample opportunities to practically apply the theoretical teachings in an education environment.

Existing simulated case studies often utilize a branched-narrative approach, which permits trainees to make incorrect assessments of a patient and continue down a path of a misdiagnosed patient. An early “wrong decision” sets a trainee on a dead-end course so as to learn the effects of a misdiagnosis so that the trainee will improve when met with a similar scenario in the future.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the pertinent art to make and use the invention. In the drawings, like reference numbers indicate identical or functionally similar elements. Additionally, the leftmost digit(s) of a reference number identifies the drawing in which the reference number first appears.

FIG. 1 shows a schematic of an example user interface of a health-care professional assessment simulation system according to an embodiment.

FIG. 2 shows an example embodiment of a method for assessing a health-care professional's competency.

FIG. 3 shows a schematic of an example user interface of a health-care professional assessment simulation system according to another embodiment.

FIG. 4 shows an example embodiment of a linear method for assessing a health-care professional's competency.

FIG. 5 illustrates a block diagram of a computer system in which embodiments of the present invention, or portions thereof, may be implemented.

### DETAILED DESCRIPTION

The following Detailed Description refers to accompanying drawings to illustrate one or more embodiments consistent with the present disclosure. The disclosed embodiment(s) merely exemplify the disclosure. References in the Detailed Description to “an example embodiment,” “an example of this embodiment,” etc., indicate that the embodiment(s) described may include a particular feature, device, or characteristic, but every embodiment may not necessarily include the particular feature, device, or characteristic. Moreover, such phrases are not necessarily referring to the same embodiment. Further, when a particular feature, device, or characteristic is described in connection with an embodiment, it is within the knowledge of those skilled in the relevant art(s) to effect such feature, device, or characteristic in connection with other embodiments whether or not explicitly described.

Although simulated case studies are useful in teaching health-care professionals, they have not been implemented in assessing the actual skill level of health-care professionals throughout the field. For example, simulated case studies have not been used for sonography simulations. That is, simulated case studies have been used for educational purposes, but they have not been used as a qualification tool for both health-care professional trainees and practicing health-care professionals. Existing assessment tools do not allow the examiner to assess how the health-care professional would perform on latter aspects of a properly-handled case.

Embodiments of the present invention are directed to systems and methods for assessing a health-care professional's ability to interpret images and diagnose a patient. Such systems and methods can be used by a health-care professional at any stage of his or her career. That is, embodiments can be utilized by a wide range of health-care professionals, from students or recent entries into the field to seasoned practitioners. Accordingly, embodiments can be used as a credential, rather than a barrier to entry. Such a credential can be used to reduce insurance premiums or as a qualification of minimum standards to practice, etc. By utilizing results of the assessments, organizations can evaluate a health-care professional's ability to evaluate content of medical images and sufficiency of displayed information related to such images, in addition to the health-care professional's ability to correctly interpret the images and information presented.

Such an assessment tool emulates what health-care professionals actually perform in their on-the-job duties. These on-the-job duties include clinical interaction between patients and the health-care professional, a review of images across a broad spectrum of modalities or fields (e.g., cardiology, pulmonology x-ray, radiology, etc.), and an assessment of images concurrent with a capture of such images. The assessment of interpretation skills of health-care professionals can thus be conducted in a setting closely modeled on actual job tasks.

According to further embodiments, each simulated case is built by a team of subject-matter experts and test-developers to model important competencies in the evaluation and interpretation of medical images and associated patient data. The subject matter experts can include health-care professional experts, such as sonographers or physicians. The test-developers can include, for example, specialists for creating, administrating, and scoring standardized competency tests.

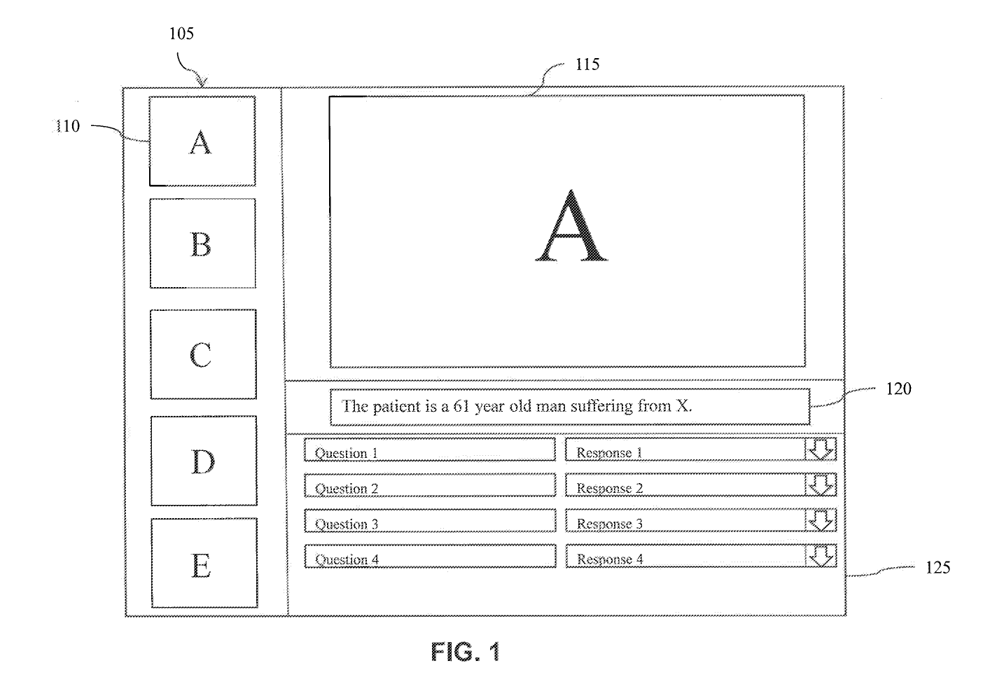

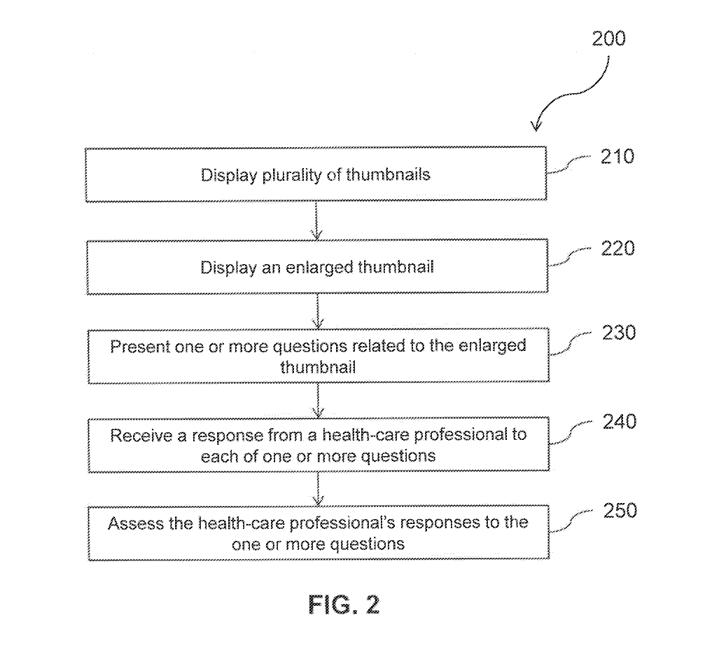

FIG. 1 shows an example user interface of a health-care professional assessment simulation system according to an embodiment. More specifically, FIG. 2 shows an example user interface of a Picture Archiving and Communication Simulation System (hereinafter “PACSim”) 105. Computer-based systems known as Picture Archiving and Communication Systems (hereinafter “PACSystem”) store and distribute medical images and documents, typically organized and presented at reading workstations. According to an embodiment of the present invention, PACSim 105 simulates the reading workstation experience. PACSim 105 presents a brief case description/summary, or clinical history. PACSim 105 also presents the basic structure of a patient interpretation report with the patient-specific interpretations remaining to be selected from among multiple response options.

According to an embodiment of the present invention, PACSim 105 provides a case study simulation to a health-care professional in order to assess his or her skills. The health-care professional being assessed can be one that uses diagnostic medical images, e.g., ultrasound images, cardiology images, pulmonology x-ray images, etc. PACSim 105 distributes the medical images to the health-care professional, and evaluates the health-care professional's interpretation of such images and other patient-related data. In this way, simulations of medical images are used to assess the health-professionals' ability to interpret medical images in the context of other patient-related data.

PACSim 105 utilizes simulated patient cases to assess image and data interpretation skills of health-care professionals. In this way, the assessment can be based on the health-care professional's ability to interpret and diagnose a patient based on a simulated case file in a setting modeled after a practical environment. PACSim 105 can be configured to present questions to the health-care professional based on what would normally be described in a patient's profile history As a result, the health-care professional can correlate clinical information to diagnose/interpret images. An output of PACSim 105 can feed into a larger competence assessment instrument, and provide information about the skill level of the health-care professional.

According to an embodiment of the present invention, the difficulty of any given simulation can be adjusted. For example, the difficulty can be adjusted through the inclusion, or omission, of relevant and irrelevant patient information in an associated case study. Structured interpretation response prompts guide the health-care professional to key interpretation points. Drop-down lists of response options allow for a realistic variety of interpretations, yet provide less clueing to a correct response than traditional limited-option multiple-choice questions. In short, traditional PACSystems are designed to produce information about the patient, whereas PACSim 105 provides information about the skill level of the health-care professional.

Referring to FIG. 1, PACSim 105 includes an image exhibit collection 110, an exhibit display 115, a case summary 120, and a response prompt portion 125. In embodiments, image exhibit collection 110 can be a collection of “thumbnails” A-E of medical images from a patient. Thumbnails A-E can be small representations of larger images. Image exhibit collection 110 may also be vertically scrollable, such that a greater number of images can be displayed. In embodiments, the images presented in image exhibit collection 110 can be based on patient-related information displayed in case summary 120. Case summary 120 can be a concise description of the patient, providing both relevant and irrelevant information. In embodiments, case summary 120 can be used to adjust the difficulty of the assessment through the inclusion or omission of relevant and irrelevant patient information, as described above. Similarly, in embodiments, the choice and quality of images selected for inclusion can impact the difficulty of the assessment.

In embodiments, image exhibit collection 110 may include still or motion/video images, such as ultrasound examinations, or other documents, such as blood work results. For ease of reference, these will all be referred to as “images” herein. The images displayed in image exhibit collection 110 can be used to build an entire profile for a patient. For example, the images can include sonographic images, cardiology images, pulmonary x-ray images, etc., which can be used to build a larger overall clinical history for the patient. It should be understood by those of ordinary skill in the art that any other type of medical images may also be included.

In embodiments, when one of thumbnails A-E in image exhibit collection 110 is selected, e.g., thumbnail A, a large, detailed version of that image can be displayed in exhibit display 115 as shown in FIG. 1. A zoom feature can also be used by the health-care professional to enlarge the selected image, thereby enabling the health-care professional to view fine details of the image.

In embodiments of the present invention, response prompt portion 125 can be used to assess the health-care professional's understanding of each image from exhibit collection display 110 as it is presented in exhibit display 115, and consequently, the health-care professional's overall assessment of the case. As each image is displayed in exhibit display 115, one or more questions related to the displayed image can be presented to the health-care professional in response prompt portion 125 in order to assess the health-care professional's interpretation of the image. Response prompt portion 125 can include questions and/or statements directed to specific issues that are most frequently encountered by health-care professionals in the field. FIG. 1 includes space for four questions and corresponding responses. However, it should be understood by those of ordinary skill in the art that any number of questions and responses can be included.

In traditional PACSystems, the health-care professional would dictate or type a summary of findings, typically following a logical flow in addressing and interpreting a series of touch points appropriate to the body part and problem being evaluated. In PACSim 105, though, response prompt portion 125 can include questions based on key subject matter, e.g., critical portions of the touch points, that health-care professionals would address when describing the case in a case summary. The critical portions of the touch points can be determined by one or more subject matter experts. Furthermore, response prompt portion 125 can be directed to a finite universe of potential responses addressing the key subject matters. In this way, response prompt portion 125 structures and limits the report to key points that can be used to distinguish competent from incompetent interpretations.

In embodiments of the present invention, for ease of scoring responses, the health-care professional is directed to select the correct, or best, answer to the response prompt from a limited set of options. The options may be presented, for example, in a drop-down list. In embodiments, the responses can be selected by the one or more subject matter experts. The use of drop-down lists for the response options allows for realistic variety of interpretations, providing less clueing to correct response than traditional limited-option multiple-choice questions. In this way, the structured response prompt portion 125 can guide health-care professionals to key interpretation points, and the health-care professional is presented with options critical to assessing the health-care professional's competency. It should be understood that other methods of providing a set of response options are further contemplated by the present invention. For example, a health-care professional's response can be retrieved via a text box or voice recognition.

According to an embodiment of the present invention, each of the health-care professional's responses in response prompt portion 125 can be scored separately and contribute to the total test score as a single item. For example, each prompt response can contribute one point to the total item score. Alternatively, different values can be awarded based on a scaled score corresponding to the selection of different response options. For example, a best choice may receive full credit, viable options may receive partial credit, and completely incorrect options may receive no credit. As a result, scoring can be customized to provide the greatest contribution toward reliability and validity for the examination as a whole.

In embodiments, scoring of PACSim 105 can be a summation of a number of correct responses selected or based on degrees of correctness among the multiple response options. Scoring can also include, but is not limited to, process data about time spent on different images, rationales for correct responses, common misconceptions, etc. In embodiments, scores, whether a summation of correct/incorrect responses or a degree of correctness, can be combined with information gleaned from other types of assessments, such as conventional multiple-choice items, to expand the content and skill domains being assessed. In embodiments, feedback can also be provided to the health-care professional. Such feedback can include, but is not limited to, process data about time spent on different images, rationales for correct responses, common misconceptions, etc.

In embodiments, an output from PACSim 105 flows back to a testing system via, e.g., communications interface 524. The output can include the health-care professional's choice of response options for each response prompt, the associated item score, the time spent on the patient case, and other ancillary data about the testing experience. In embodiments, the scores from a PACSim 105 assessment can be combined with other testing formats, such as conventional multiple-choice questions, to provide insight into the health-care professional's ability to competently perform a critical job skill and interpret the medical images and information in a setting modeled after a practical environment.

FIG. 2 shows an example embodiment of a method for assessing a health-care professional's competency. More specifically, FIG. 2 shows a method 200 for assessing a health-care professional's competency using PACSim 105 described above. The method 200 includes displaying a plurality of thumbnails of medical images on a user interface at block 210. The method 200 further includes displaying an enlarged medical image of one of the thumbnails selected by a health-care professional and a case summary of a simulated patient at block 220. Furthermore, the method 200 includes presenting one or more questions related to key aspects to the health-care professional at block 230. Lastly, the method 200 includes receiving a response from the health-care professional at block 240 and assessing of the health-care professional's interpretation of the images at block 250.

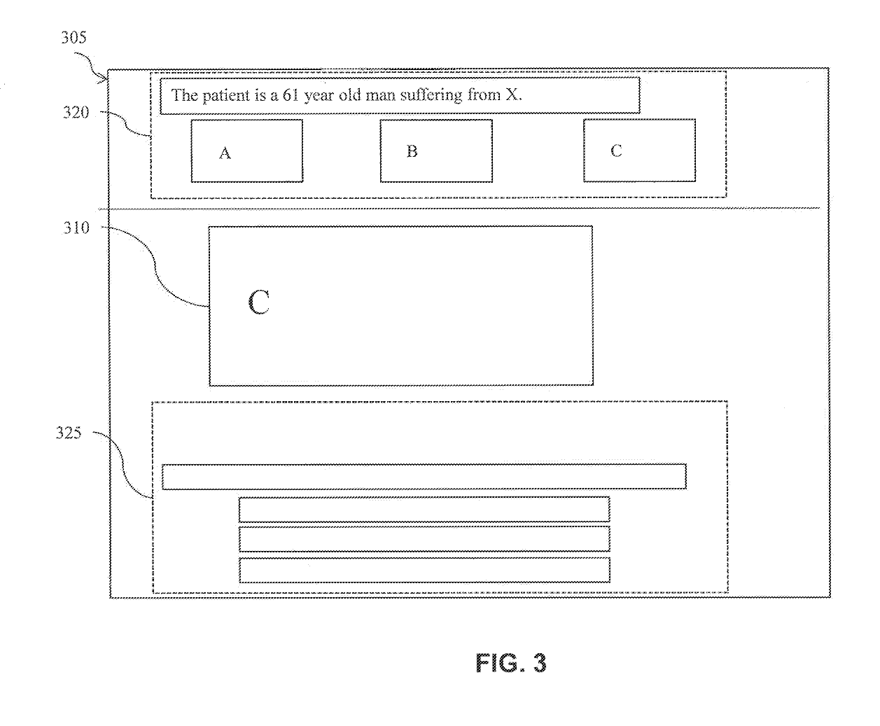

FIG. 3 shows a schematic of an example interface of a health-care professional assessment simulation system, according to an embodiment. In embodiments of the present invention, a Progressive Clinical and Image Case Simulations (hereinafter “PCICS”) system 305 mimics the developing nature of a point-of-care (“POC”) clinical experience, while assuring that all health-care professionals approach key decision-making junctures with the same basis of information. This avoids an inherent flaw in many progressive, branched-narrative simulations—early correct and incorrect decisions result in different situations relevant to later decisions, making it difficult to assess the competency of a health-care professional. For example, a minor error at the beginning of an assessment may result in a disastrous final outcome, while a minor error at the end of an assessment may not affect the final outcome as much.

In embodiments, PCICS system 305 advantageously provides information about a correct course of action after the health-care professional's choice from a standard list of actions or interpretations is recorded. In an embodiment, the correct course of action can be provided when the correct response will affect subsequent decision making (hereinafter “critical”). In alternative embodiments, the correct course of action can also be provided at other times during the simulation. That is, the simulation is a linear narrative. A health-care professional is guided along a correct interpretation/diagnosis of a patient, thereby avoiding at least one of the pitfalls of the POC systems. As a result of all health-care professionals being guided along a correct path, an increased number of data points is available to assess the health-care professional. In contrast, when a health-care professional follows an incorrect path in a traditional branched narrative system, only a limited number of data points are available.

In an embodiment, PCICS cases are structured in distinct stages, with a relevant subset(s) of questions asked after an introduction of each new piece of information. The new information can include an updated image or other patient related information. For example, in embodiments, the image can be a repeating video clip of a medical image, e.g., an ultrasound motion image. In embodiments, each case has the same “introductory” and “conclusive” questions and a set of “presentation” questions for the presentation of new information. In embodiments, one or more of the “presentation questions” may be used after the presentation of each new piece of information depending on the information being assessed; however, it would be understood by those of ordinary skill in the art that different “introductory”, “presentation” and “conclusive” questions are contemplated by embodiments of the present invention. Furthermore, in embodiments, the health-care professional can revisit a clinical narrative, but the health-care professional can be precluded from revisiting or changing earlier responses.

PCICS system 305 enables the efficient development of cases. A case study develops as a health-care professional progresses further and further into the simulation, and more information is provided to the health-care professional. To create a case study simulation, subject matter experts (SMEs) are provided with an electronic survey which asks for a description of a case study, according to an embodiment. The survey may include key characteristics of the case. The survey allows the SMEs to upload images for presentation to the health-care professional at decision points. Any additional information to be provided is typed into a response box. Supplemental media images, such as patient lab work introduced during the case, can also be added at decision points.

The survey can further include a list of standard questions, for example the “introductory”, “presentation,” and “conclusive” questions, for the SME to select responses for. These questions may then be asked of the health-care professional when appropriate, such as after the introduction of new images or information into the clinical vignette. For each of the indicated questions, the correct answer(s) is indicated by the SME. In this way, the SME builds the PCICS case incrementally, adding images and information to be provided to the health-care professionals and indicating the correct action or interpretation at each scoring opportunity. The case, images, and answers are recorded in a database for later presentation as examination items.

Referring to FIG. 3, in embodiments of the present invention, PCICS system 305 includes a case summary 320 and a response prompt portion 325. Case summary 320 can be a concise description of the patient, providing both relevant and irrelevant information. Case summary 320 can be a vignette or a narrative, which describes a current status of the patient. As a health-care professional progresses through a simulation, case summary 320 can include additional information relevant to the status of the patient. In embodiments, case summary 320 can be used to adjust the difficulty of the assessment through the inclusion or omission of relevant and irrelevant patient information. Similarly, in embodiments, the choice and quality of images selected for inclusion can impact the difficulty of the assessment.

Case summary 320 can include still or motion images A-C, such as either still or motion images, such as sonographic images, cardiology images, pulmonary images, etc., or other documents, such as blood work results. For ease of reference, these will all be referred to as “images” herein. The images displayed in case summary 320 can be used to build an entire profile for a patient. For example, the images can include sonographic images, cardiology images, pulmonary x-ray images, etc., which can be used to build a larger overall clinical profile for the patient. It should be understood by those of ordinary skill in the art that other types of medical images also fall within the scope of the present invention. Case summary 320 will grow as the case progresses and new information is introduced into the clinical vignette.

In embodiments, PCICS system 305 further includes an exhibit portion 310, which can be displayed as a health-care professional progresses through a simulation. Exhibit portion 310 may include any newly introduced images from case summary 320, about which questions are presented.

In embodiments of the present invention, response prompt portion 325 can be used to assess the health-care professional's understanding of the information provided in case summary 320, focusing on any images presented in exhibit portion 310, e.g., image C. As information and images are provided to the health-care professional using case summary 320 and exhibit portion 310, respectively, one or more questions and/or statements can be presented to the health-care professional in response prompt portion 325. Such questions and/or statements can be directed to specific issues that are most frequently encountered by health-care professionals in the field. The health-care professional can then be assessed on the health-care professional's interpretation of each of the images and diagnosis of the patient.

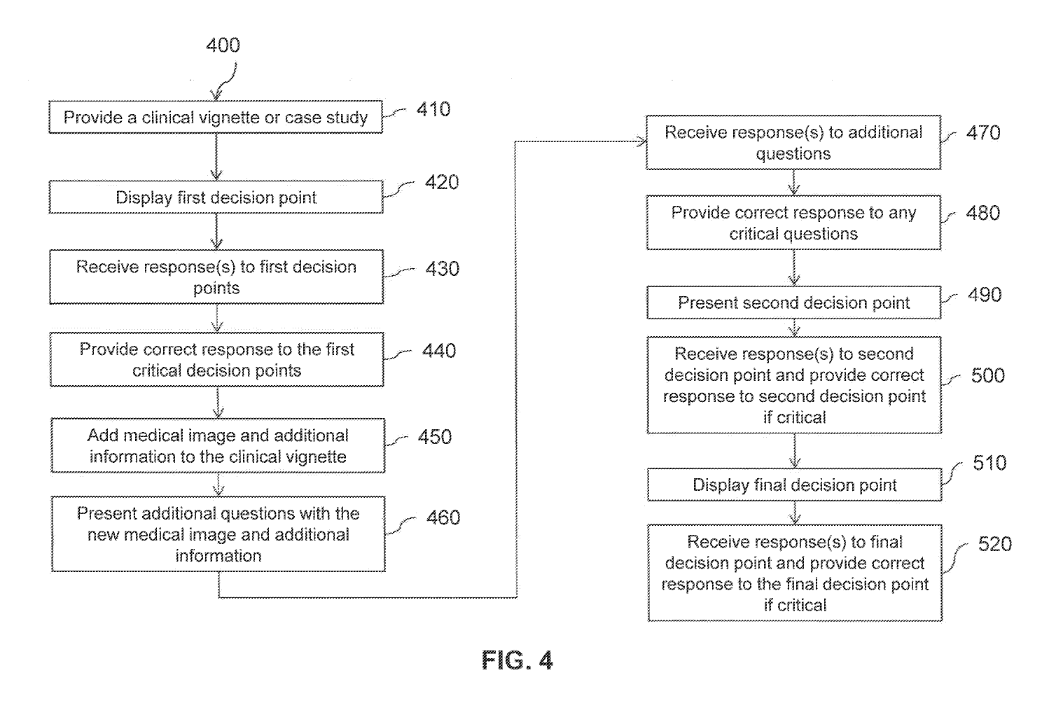

FIG. 4 shows an example embodiment of a linear simulation method 400 for assessing a health-care professional's competency using the PCICS system 305. Although the exemplary simulation is described with respect to ultrasound images, it should be understood by those of ordinary skill in the art that any healthcare field which utilizes captured images is also contemplated by the present invention. For example, the simulation can be based on cardiology images, pulmonology x-ray images, radiology images, etc. In embodiments, the method 400 includes providing, via case summary 320, a health-care professional with a vignette or narrative of a case study simulation at block 410. The clinical vignette can describe, for example, a hypothetical situation including the role of the health-care professional and the current state of the patient. In embodiments, the clinical vignette or narrative can highlight critical information, e.g., timing information, for the health-care professional. Such critical timing information can be essential to emergency health-care professionals, such as emergency medical technicians, paramedics, mid-wives, etc.

The method 400 further includes displaying, via response prompt portion 325, a first decision point. The first decision point can include a series of one or more opening questions based on information provided in the vignette at block 420. The one or more questions can include, but are not limited to:
Whether an ultrasound is appropriate?
If ultrasound is appropriate, what are you looking for or how might ultrasound help?
What image is necessary?
What is the pre-test probability of diagnosing the patient using ultrasound?
Are patient priorities being met?

After the health-care professional provides a response to the one or more opening questions at block 430, the health-care professional is provided with a correct response to each of the questions at block 440 that may affect upcoming decisions, regardless of how the health-care professional responded. As a result, a health-care professional that provided an incorrect response is not disadvantaged. From an assessment standpoint, all health-care professionals will answer the same questions based on the corrected diagnosis/interpretation, thereby providing a greater number of common assessment data points.

After the correct responses to the first critical decision points are provided to the health-care professional, a medical image along with additional information can be provided to the health-care professional at block 450 by adding it to case summary 320. At any point in time, the health-care professional can go back to review the most current information for the scenario by reviewing case summary 320. However, in an embodiment, the health-care professional cannot revisit or revise any previous questions or responses. Furthermore, the image provided to the health-care professional at block 450 can be carried through to one or more subsequent questions. Additional questions related to the image and the additional information can be presented to the health-care professional at block 460. The questions can include, but are not limited to:

What is the image quality?

What kind of view is being shown?

Where should transducer be placed to obtain this view?

What is the transducer placement?

What is the transducer orientation?

What structure can be identified?

What ultrasound signs can be detected?

What type of transducer was used to take the image?

After the health-care professional responds to one or more of the above questions at block 470, the health-care professional is again provided with the correct responses to any critical questions at block 480. The health-care professional may subsequently be presented with a second decision point based on the corrected responses at block 490. The health-care professional can be asked, for example, one or more of the following questions:

What are you going to do next?

Do you need another view?

Can you make a diagnosis? Or are you unable to make a diagnosis?

In embodiments, any number of images and decision points can be presented to the health-care professional. For each decision point presented to the health-care professional, after the health-care professional provides a response, the health-care professional is provided with the correct response at block 500 if the correct response is critical, such that the health-care professional is fully abreast of what the correct course of conduct is. After a final image is presented, the health-care professional can be prompted with a final decision point in order to make a final diagnosis and state a conclusion at block 510. Accordingly, the health-care professional can be prompted to make a final diagnosis based on all of the information presented throughout the case study at block 510. To determine a final diagnosis, the health-care professional can review the entire case presented by reviewing case summary 320, including the vignette/narrative, any previously presented images, and all of the information previously presented.

The conclusion questions can also be a linear progression, such that the health-care professional is directed along a path and remains abreast of the correct interpretations along that path. That is, the questions to reach the final diagnosis are not interdependent. To achieve this, after the health-care professional responds to the final decision point, the health-care professional is presented with the correct response and each subsequent question is based on the correct response at block 520. For example, a second question is based on a correct answer for a first question, and so on. The final questions can include, but are not limited to:

Question 1—What patterns can be identified?

Question 2—Based on a correct pattern of X, what is your diagnosis?

In embodiments, scoring of PCICS system 5 can be a summation of a number of correct responses selected, or based on degrees of correctness among the multiple response options. Scoring can also include, but is not limited to, process data about time spent on different images, rationales for correct responses, common misconceptions, etc. In embodiments, scores, whether a summation of correct/incorrect responses or a degree of correctness, can be combined with information gleaned from other types of assessments, such as conventional multiple-choice items, to expand the content and skill domains being assessed.

According to aspects of the present invention, both formative and summative evaluations can be achieved. When administered for summative, final pass/fail purposes, the simulations provide a learning experience through the progressive feedback that also serves the assessment goal of having each health-care professional approach each scoring opportunity with the same background information. An optional enhancement allows for the provision of additional feedback or teaching to the health-care professional after the health-care professional's responses have been submitted. If desired, the health-care professional can be permitted to review their responses, the correct responses, and SME-provided feedback, rationales, or links to resources for the entire case and each decision point.

The embodiments described herein are provided for illustrative purposes, and are not limiting. Other embodiments are possible, and modifications can be made to the embodiments within the spirit and scope of the present disclosure. Therefore, the Detailed Description is not meant to limit the present disclosure. Rather, the scope of the present disclosure is defined only in accordance with the following claims and their equivalents.

Some embodiments of the disclosure may be implemented in hardware, firmware, software, or any combination thereof. Some embodiments of the disclosure can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

It is to be understood that the phraseology or terminology herein is for the purpose of description and not of limitation, such that the terminology or phraseology of the present specification is to be interpreted by those skilled in relevant art(s) in light of the teachings herein.

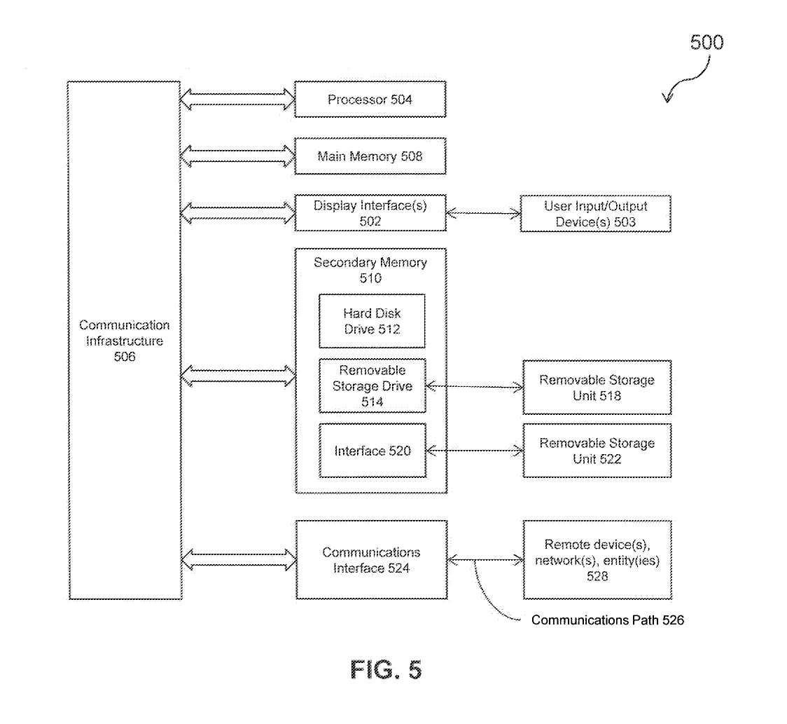

Various aspects of the present invention may be implemented in software, firmware, hardware, or a combination thereof. FIG. 5 is an illustration of an example computer system 500 in which embodiments of the present invention, or portions thereof, can be implemented as computer-readable code. For example, the methods illustrated by flowcharts 200 and 400 of FIGS. 2 and 4, respectively, can be implemented in system 500. Various embodiments of the present invention are described in terms of this example computer system 500. After reading this description, it will become apparent to a person skilled in the relevant art how to implement embodiments of the present invention using other computer systems and/or computer architectures.

It should be noted that the simulation, synthesis and/or manufacture of various embodiments of this invention may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any computer-readable medium including a semiconductor, magnetic disk, and/or optical disk (such as CD-ROM, DVD-ROM). As such, the code can be transmitted over communication networks including the Internet. The functions accomplished and/or structure provided by the systems and techniques described above can be represented in a memory.

Computer system 500 includes one or more processors, such as processor 504. Processor 504 is connected to a communication infrastructure 506 (e.g., a bus or network).

Computer system 500 also includes a main memory 508, such as random access memory (RAM), and may also include a secondary memory 510. Secondary memory 510 can include, for example, a hard disk drive 512, a removable storage drive 514, and/or a memory stick. Removable storage drive 514 can include a floppy disk drive, a magnetic tape drive, an optical disk drive, a flash memory, or the like. The removable storage drive 514 reads from and/or writes to a removable storage unit 518 in a well-known manner. Removable storage unit 518 can include a floppy disk, magnetic tape, optical disk, flash drive, etc., which is read by and written to by removable storage drive 514. As will be appreciated by persons skilled in the relevant art, removable storage unit 518 includes a computer-readable storage medium having stored therein computer software and/or data. Computer system 500 includes a display interface 502 (which can include input and output devices 503 such as keyboards, mice, etc.) that forwards graphics, text, and other data from communication infrastructure 506 (or from a frame buffer not shown).

In alternative implementations, secondary memory 510 can include other similar devices for allowing computer programs or other instructions to be loaded into computer system 500. Such devices can include, for example, a removable storage unit 522 and an interface 520. Examples of such devices include a program cartridge and cartridge interface (such as those found in video game devices), a removable memory chip (e.g., EPROM or PROM) and associated socket, and other removable storage units 522 and interfaces 520 which allow software and data to be transferred from the removable storage unit 522 to computer system 500.

Computer system 500 can also include a communications interface 524. Communications interface 524 allows software and data to be transferred between computer system 500 and external devices. Communications interface 524 can include a modem, a network interface (such as an Ethernet card), a communications port, a PCMCIA slot and card, or the like. Software and data transferred via communications interface 524 are in the form of signals which may be electronic, electromagnetic, optical, or other signals capable of being received by communications interface 524. These signals are provided to communications interface 524 via a communications path 526. Communications path 526 carries signals and can be implemented using wire or cable, fiber optics, a phone line, a cellular phone link, a RF link or other communications channels.

In this document, the terms “computer program storage medium” and “computer-readable storage medium” are used to generally refer to non-transitory media such as removable storage unit 518, removable storage unit 522, and a hard disk installed in hard disk drive 512. Computer program storage medium and computer-readable storage medium can also refer to memories, such as main memory 508 and secondary memory 510, which can be memory semiconductors (e.g., DRAMs, etc.). Embodiments of the present invention can employ any computer-readable medium, known now or in the future. Examples of computer-readable storage mediums include, but are not limited to, non-transitory primary storage devices (e.g., any type of random access memory), and non-transitory secondary storage devices (e.g., hard drives, floppy disks, CD ROMS, ZIP disks, tapes, magnetic storage devices, optical storage devices, MEMS, nanotechnological storage devices, etc.).

These computer program products provide software to computer system 500. Embodiments of the present invention are also directed to computer program products including software stored on any computer-readable storage medium. Such software, when executed in one or more data processing devices, causes a data processing device(s) to operate as described herein.

Computer programs (also called computer control logic) are stored in main memory 508 and/or secondary memory 510. Computer programs may also be received via communications interface 524. Such computer programs, when executed, enable computer system 500 to implement embodiments of the present invention as discussed herein. In particular, the computer programs, when executed, enable processor 504 to implement processes of embodiments of the present invention, such as the steps in the methods illustrated by flowcharts 200 and 400 of FIGS. 2 and 4, respectively, can be implemented in system 500. Where embodiments of the present invention are implemented using software, the software can be stored in a computer program product and loaded into computer system 500 using removable storage drive 514, interface 520, hard drive 512, or communications interface 524.

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus, the present invention should not be limited by any of the above described exemplary embodiments, but should be defined only in accordance with the following claims and their equivalents.

What is claimed:

1. A system for assessing competency of a health-care professional, comprising:
a virtual console configured to present an assessment scenario to the health-care professional, the virtual console including:
an image section having a plurality of digital images based on a simulated patient;
an enlarged digital image, wherein the enlarged digital image is one of the plurality of digital images selected by the health-care professional; and
a response prompt portion having one or more questions related to the enlarged digital image; and
an assessment tool associated with the virtual console, the assessment tool configured to perform an assessment of the health-care professional's interpretation of each of the plurality of digital images.

2. The system of claim 1, wherein the one or more questions of the prompt response portion are directed to critical portions of touch points of the enlarged digital imaged, wherein the critical portions are determined by one or more subject matter experts.

3. The system of claim 2, wherein responses to the one or more questions are listed in a drop-down box and selected by the one or more subject matter experts.

4. The system of claim 2, wherein a response to the one or more questions of the prompt response portion is scored based on a scale, wherein a best choice receives full credit, viable options receive partial credit, and incorrect options receive no credit.

5. The system of claim 1, wherein the plurality of digital images includes at least one of still images, motion images, or medical documents.

6. The system of claim 5, wherein the still images and the motion images are images retrieved from an ultrasound examination.

7. The system of claim 1, wherein the virtual console further includes a case summary portion, and a difficulty of the assessment scenario is adjusted by altering information provided in the case summary portion.

8. The system of claim 1, wherein an output of the assessment tool is provided to an overall testing system used to assess the health-care professional.

9. A system for assessing competency of a health-care professional using a linear narrative progression, comprising:
a virtual console configured to:
present a clinical vignette to the health-care professional;
display a series of digital images and a series of one or more questions to the health-care professional based on the clinical vignette;
receive a response to each of the questions; and
display corrective instructions to the health-care professional after receiving a response to critical questions, wherein subsequent digital images and questions are based on the corrective instructions; and
an assessment tool associated with the virtual console, the assessment tool configured to perform an assessment of the health-care professional's interpretation of each of the plurality of digital images.

10. The system of claim 9, wherein the series of one or more questions is based on information related to a displayed image, wherein a final question of the series of one or more questions is a decision point.

11. The system of claim 10, wherein the series of one or more questions is determined by one or more subject matter experts.

12. The system of claim 9, wherein the series of digital images include at least one of still images, motion images, or medical documents.

13. The system of claim 12, wherein the still images and the motion images are images retrieved from an ultrasound examination.

14. The system of claim 9, wherein a difficulty of the assessment is adjusted by altering information provided to the health-care professional.

15. The system of claim 9, wherein the virtual console is further configured to:
provide feedback to the health-care professional after the assessment has been completed, wherein the feedback comprises:
responses submitted by the health-care professional, the corrective instructions, subject matter expert feedback, and links to resources for the series of digital images and each decision point.

16. The system of claim 9, wherein the virtual console is further configured to:
permit a review of the linear narrative progression up to a currently displayed image; and
preclude the health-care professional from altering responses after submission.

17. A method of assessing a competency of a health-care professional using a linear-branched narrative, comprising:
displaying a clinical vignette of a simulated patient to the health-care professional;
presenting one or more decision points to the health-care professional;
receiving a response to each of the one or more decision points from the health-care professional;
providing a correct response to one or more critical decision points to the health-care professional regardless of the received response to the one or more decision points, wherein a subsequent decision point is based on the correct response to a previous decision point; and
assessing the competency of the health-care professional based on the responses to each of the one or more decision points, wherein the assessing the competency of the health-care professional is performed using a processor of a computing device.

18. The method of claim 17, further comprising:
providing a medical image to the health-care professional;
presenting one or more questions based on the medical image to the health-care professional;
receiving a response to each question; and
displaying a correct response to critical questions regardless of the received response to each question, wherein a decision point following the one or more questions is based on each of the correct responses.

19. The method of claim 18, wherein the medical image is a still image or a motion image retrieved from an ultrasound examination.

20. The method of claim 17, further comprising providing feedback to the health-care professional after the assessment has been completed.
